(19) United States
(12) Patent Application Publication
(10) Pub. No.: US 2021/0045373 A1
(43) Pub. Date: Feb. 18, 2021

(54) Fishing Bobber Apparatus

(71) Applicant: Roy McMahon, Imperial, PA (US)

(72) Inventor: Roy McMahon, Imperial, PA (US)

(21) Appl. No.: 16/540,256

(22) Filed: Aug. 14, 2019

(51) Int. Cl. A01K 93/02

(52) U.S. Cl. CPC A01K 93/02

(57) ABSTRACT

A fishing bobber apparatus for controlled hook depth and improved fishing includes a float having a float aperture centrally extending from a top end of a head portion through a neck portion and a body portion. The float is buoyant. A chamber is coupled to the float. A base weight is coupled to the chamber. A base inner side is funnel-shaped and has a central base aperture. A rigid line tube is coupled to the float. A pinch tube is coupled to the line tube. The line tube and the pinch tube are configured to slidably receive a fishing line. The pinch tube is malleable and configured to secure the fishing line in place when pinched. A weight ball is coupled within the chamber. The weight ball rests on the base inner side and pinches the pinch tube when the apparatus is in an upright position.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fishing bobbers and more particularly pertains to a new fishing bobber for controlled hook depth and improved fishing.

### (2) Description of Related Art Including Information Disclosed Under 37 CFR 1.97 and 1.98

The prior art relates to fishing bobbers.

### BRIEF SUMMARY OF THE INVENTION

An embodiment of the disclosure meets the needs presented above by generally comprising a float having a head portion, a neck portion, and a body portion. The float has a float aperture centrally extending from a top end of the head portion through the neck portion and the body portion. The float is buoyant. A chamber is coupled to the float. The chamber has an open chamber top side coupled to the body portion, a chamber sidewall, and an open chamber bottom side defining a chamber cavity. The chamber sidewall has a fill aperture extending therethrough. A base weight is coupled to the chamber. The base weight is coupled to the chamber bottom side. A base inner side is funnel-shaped and has a central base aperture extending through a base outer side. A rigid line tube is coupled to the float. The line tube is coupled within the float aperture and extends into the chamber cavity. A pinch tube is coupled to the line tube. The pinch tube is coupled to a tube bottom end of the line tube within the chamber cavity and extends through the base aperture to the base outer side. The line tube and the pinch tube are configured to slidably receive a fishing line. The pinch tube is malleable and configured to secure the fishing line in place when pinched. A weight ball is coupled within the chamber. The weight ball rests on the base inner side and pinches the pinch tube when the apparatus is in an upright position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a fishing bobber apparatus according to an embodiment of the disclosure.

FIG. 2 is a side elevation view of an embodiment of the disclosure.

FIG. 3 is a rear elevation view of an embodiment of the disclosure.

FIG. 4 is a front elevation view of an embodiment of the disclosure.

FIG. 5 is a cross-sectional view along the line 5-5 of FIG. 4 of an embodiment of the disclosure.

FIG. 6 is an in-use view of an embodiment of the disclosure.

### DETAILED DESCRIPTION OF THE INVENTION

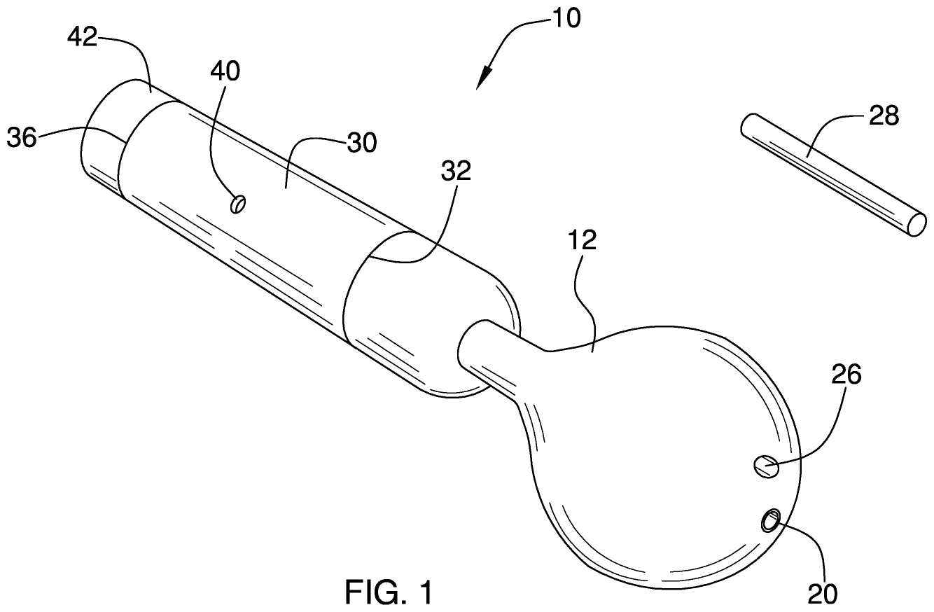

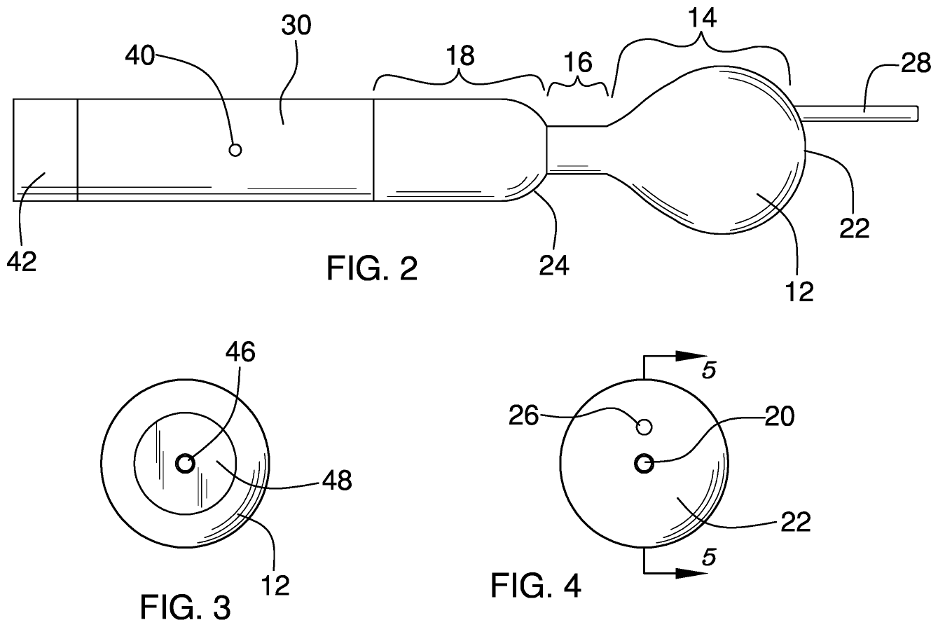

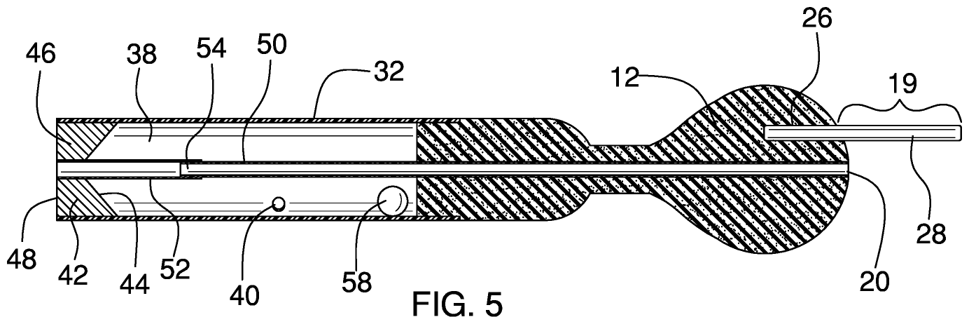

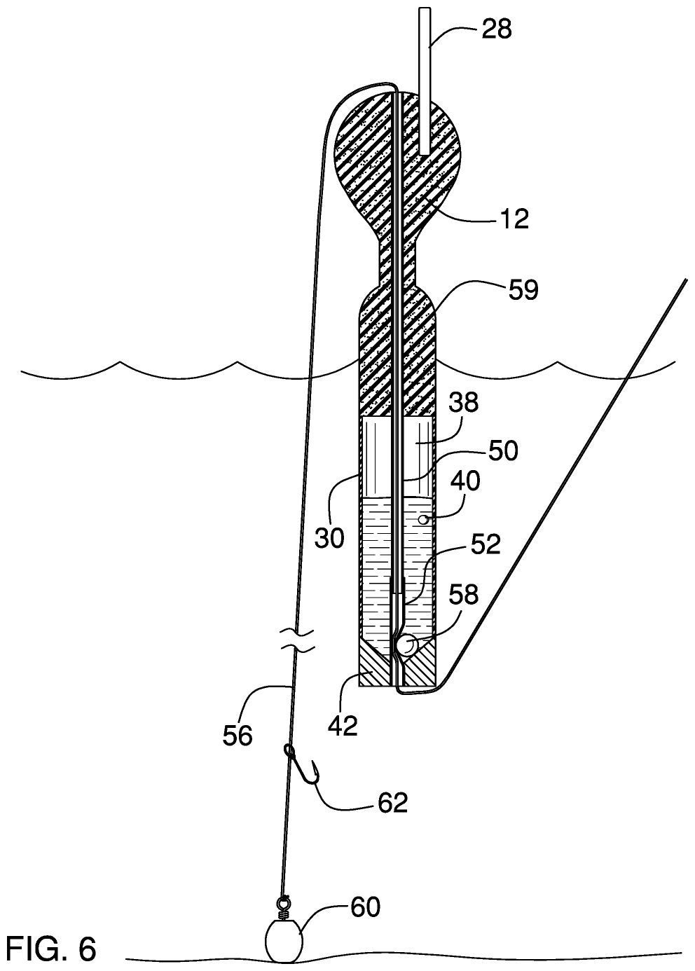

With reference now to the drawings, and in particular to FIGS. 1 through 6 thereof, a new fishing bobber embodying the principles and concepts of an embodiment of the disclosure and generally designated by the reference numeral 10 will be described.

As best illustrated in FIGS. 1 through 6, the fishing bobber apparatus 10 generally comprises a float 12 having a head portion 14, a neck portion 16, and a body portion 18. The float 12 has a float aperture 20 centrally extending from a top end 22 of the head portion 14 through the neck portion 16 and the body portion 18. The head portion 14 and the neck portion 16 of the float 12 are bulb-shaped. The body portion 18 has a rounded shoulder edge 24 adjacent the neck portion 16. A width of the body portion 18 is greater than a width of the neck portion 16 and less than a width of the head portion 14. The float 12 is buoyant. The head portion 14 has a cylindrical slot 26 extending through the top end 22 proximal to, and parallel with, the float aperture 20. The slot 26 is configured to partially receive a glowstick 28. The glowstick 28 has an exposed portion 29 protruding from the head portion 14 to show position and movement more easily while fishing at night.

A chamber 30 is coupled to the float 12. The chamber 30 has an open chamber top side 32 coupled to the body portion 18, a chamber sidewall 34, and an open chamber bottom side 36 defining a chamber cavity 38. The chamber sidewall 34 has a fill aperture 40 extending therethrough. A base weight 42 is coupled to the chamber bottom side 36. A base inner side 44 is funnel-shaped and has a central base aperture 46 extending through a base outer side 48. A width of the chamber 30 and a width of the base weight 42 may be equal to the width of the body portion 18. A rigid line tube 50 is coupled within the float aperture 20 and extends into the chamber cavity 38. A pinch tube 52 is coupled to the line tube 50. The pinch tube 52 is coupled to a tube bottom end 54 of the line tube 50 within the chamber cavity 38 and extends through the base aperture 46 to the base outer side 48. The pinch tube 52 is sealingly coupled around the tube bottom end 54. The line tube 50 and the pinch tube 52 are configured to slidably receive a fishing line 56. The pinch tube 52 is malleable and configured to secure the fishing line 56 in place when pinched. The pinch tube 52 may be a rubberized tubing such as, but not limited to, surgical tubing and the like. A weight ball 58 is coupled within the chamber 30. The weight ball 58 rests on the base inner side 44 and pinches the pinch tube 52 when the apparatus 10 is in an upright position 59.

In use, the fishing line 56 is fed through the line tube 50 and the pinch tube 52 and connected to a sinker 60 and a hook 62. The apparatus 10 is cast out and floats on its side as the sinker 60 reaches the bottom of the body of water being fished in. The fill aperture 40 allows the chamber cavity 38 to partially fill with water moving the apparatus 10 to the upright position 59, causing the weight ball 58 to fall to the base inner side 44 and pinch the pinch tube 52 to secure the fishing line. The apparatus 10 maintains the fishing line 56 leading to the sinker being more upright and thus keeps the hook 62 at a preset height to prevent bait from lying on the bottom or getting hidden under rocks or in weeds.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fishing bobber apparatus comprising:
a float, the float having a head portion, a neck portion, and a body portion, the float having a float aperture centrally extending from a top end of the head portion through the neck portion and the body portion, the float being buoyant;
a chamber coupled to the float, the chamber having an open chamber top side coupled to the body portion, a chamber sidewall, and an open chamber bottom side defining a chamber cavity, the chamber sidewall having a fill aperture extending therethrough;
a base weight coupled to the chamber, the base weight being coupled to the chamber bottom side, a base inner side being funnel-shaped and having a central base aperture extending through a base outer side;
a rigid line tube coupled to the float, the line tube being coupled within the float aperture and extending into the chamber cavity;
a pinch tube coupled to the line tube, the pinch tube being coupled to a tube bottom end of the line tube within the chamber cavity and extending through the base aperture to the base outer side, the line tube and the pinch tube being configured to slidably receive a fishing line, the pinch tube being malleable and configured to secure the fishing line in place when pinched; and
a weight ball coupled within the chamber, the weight ball resting on the base inner side and pinching the pinch tube when the apparatus is in an upright position.

2. The fishing bobber apparatus of claim 1 further comprising the head portion and the neck portion of the float being bulb-shaped, the body portion having a rounded shoulder edge adjacent the neck portion.

3. The fishing bobber apparatus of claim 1 further comprising a width of the body portion being greater than a width of the neck portion and less than a width of the head portion, a width of the chamber and a width of the base weight being equal to the width of the body portion.

4. The fishing bobber apparatus of claim 1 further comprising the pinch tube being sealingly coupled around the tube bottom end.

5. The fishing bobber apparatus of claim 1 further comprising the head portion of the float having a cylindrical slot, the slot being configured to receive partially receive a glowstick.

6. The fishing bobber apparatus of claim 5 further comprising the slot extending through the top end proximal to, and parallel with, the float aperture.

7. A fishing bobber apparatus comprising:
a float, the float having a head portion, a neck portion, and a body portion, the float having a float aperture centrally extending from a top end of the head portion through the neck portion and the body portion, head portion and the neck portion of the float being bulb-shaped, the body portion having a rounded shoulder edge adjacent the neck portion, a width of the body portion being greater than a width of the neck portion and less than a width of the head portion, the float being buoyant, the head portion having a cylindrical slot extending through the top end proximal to, and parallel with, the float aperture, the slot being configured to receive partially receive a glowstick;
a chamber coupled to the float, the chamber having an open chamber top side coupled to the body portion, a chamber sidewall, and an open chamber bottom side defining a chamber cavity, the chamber sidewall having a fill aperture extending therethrough;
a base weight coupled to the chamber, the base weight being coupled to the chamber bottom side, a base inner side being funnel-shaped and having a central base aperture extending through a base outer side, a width of the chamber and a width of the base weight being equal to the width of the body portion;
a rigid line tube coupled to the float, the line tube being coupled within the float aperture and extending into the chamber cavity;
a pinch tube coupled to the line tube, the pinch tube being coupled to a tube bottom end of the line tube within the chamber cavity and extending through the base aperture to the base outer side, the pinch tube being sealingly coupled around the tube bottom end, the line tube and the pinch tube being configured to slidably receive a fishing line, the pinch tube being malleable and configured to secure the fishing line in place when pinched; and
a weight ball coupled within the chamber, the weight ball resting on the base inner side and pinching the pinch tube when the apparatus is in an upright position.

8. A fishing bobber apparatus and glowstick assembly comprising:
a float, the float having a head portion, a neck portion, and a body portion, the float having a float aperture centrally extending from a top end of the head portion through the neck portion and the body portion, the head portion and the neck portion of the float being bulb-shaped, the body portion having a rounded shoulder edge adjacent the neck portion, a width of the body portion being greater than a width of the neck portion and less than a width of the head portion, the float being buoyant, the head portion having a cylindrical slot extending through the top end proximal to, and parallel with, the float aperture;
a glowstick, the glowstick being partially engageable within the slot;
a chamber coupled to the float, the chamber having an open chamber top side coupled to the body portion, a chamber sidewall, and an open chamber bottom side defining a chamber cavity, the chamber sidewall having a fill aperture extending therethrough;
a base weight coupled to the chamber, the base weight being coupled to the chamber bottom side, a base inner side being funnel-shaped and having a central base aperture extending through a base outer side, a width of the chamber and a width of the base weight being equal to the width of the body portion;
a rigid line tube coupled to the float, the line tube being coupled within the float aperture and extending into the chamber cavity;
a pinch tube coupled to the line tube, the pinch tube being coupled to a tube bottom end of the line tube within the chamber cavity and extending through the base aperture to the base outer side, the pinch tube being sealingly coupled around the tube bottom end, the line tube and the pinch tube being configured to slidably receive a fishing line, the pinch tube being malleable and configured to secure the fishing line in place when pinched; and
a weight ball coupled within the chamber, the weight ball resting on the base inner side and pinching the pinch tube when the apparatus is in an upright position.
